(19) United States
(12) Patent Application Publication
(10) Pub. No.: US 2010/0322635 A1
(43) Pub. Date: Dec. 23, 2010

(54) USING AMBIENT LED LIGHT FOR BROADCASTING INFO AND NAVIGATION

(75) Inventor: Gunnar KLINGHULT, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/486,937

(22) Filed: Jun. 18, 2009

(51) Int. Cl. H04B 10/02; H04B 10/00

(52) U.S. Cl. 398/132; 398/172

(57) ABSTRACT

A mobile device for receiving modulated light, an apparatus for transmitting information by modulated light and a system as well as corresponding methods are disclosed to be able to use at least parts of an illumination infrastructure for transmitting data to a mobile device. The mobile device comprises a visible light receiver for receiving modulated visible light carrying information corresponding to transmission data modulated onto visible light emitted from at least one light source and for outputting a signal based on the received modulated visible light, and a demodulator for demodulating said signal based on the received modulated visible light to extract said information corresponding to said transmission data.

### FIELD OF THE INVENTION

The present invention relates to a mobile device for receiving modulated light, an apparatus for transmitting information by modulated light and a system as well as methods for operating the mobile device and the system, respectively, wherein modulated light carries information corresponding to transmission data modulated onto the light emitted from a light source, in particular a light emitting diode (LED).

### BACKGROUND

Several techniques are known to transmit information to mobile devices, e.g. a mobile phone, such as different mobile communication standards including GSM (Global System for Mobile Communications), UMTS (Universal Mobile Telecommunications System), CDMA (Code Division Multiple Access), etc. Furthermore, other user activated communication connections like Bluetooth or WLAN (Wireless Local Area Network also known as Wi-Fi) are also sometimes used in mobile devices for receiving information via short range communication.

For even shorter ranges in communication, up to 100 cm, some mobile devices, such as mobile phones, laptop computers or PDAs (Personal Digital Assistant) have been adapted to provide infrared communications by comprising an IrDA—(Infrared Data Association)—interface, requiring line of sight between the communicating devices similar to a TV remote control. These IrDA transceivers communicate with infrared pulses at a data rate in the kbit/s range. Hereby no carrier is used and the infrared pulses correspond to the difference between IR light transmitted and no IR light transmitted, i.e. on and off. However, the data rate, distance and reliability of the connection, e.g. simple pulses are easily disturbed by environmental conditions, such as background light, may not be sufficient for certain applications.

All the above-described techniques for short-range communication require installation of extensive new infrastructure communicating with the mobile device, such as Bluetooth nodes using the IEEE 802.15.1 standard or WLAN-nodes using the IEEE 802.11 standard, which may lead to high investment costs.

Therefore, it would be desirable to use at least parts of an existing infrastructure for transmitting data to a mobile device.

### DISCLOSURE OF THE INVENTION

A mobile device for receiving modulated visible light and an apparatus for transmitting information by modulated visible light as well as a system comprising the mobile device and the apparatus and corresponding methods are presented, wherein the modulated visible light carries information corresponding to transmission data sent from the apparatus to the mobile device.

An embodiment of the invention provides a mobile device comprising a visible light receiver for receiving modulated visible light carrying information corresponding to transmission data modulated onto visible light emitted from at least one light source and for outputting a signal based on the received modulated visible light. The mobile device further comprises a demodulator for demodulating the signal based on the received modulated visible light to extract said information corresponding to the transmission data. For example, the information may indicate the position of the light source so that by obtaining this information from said transmission data also the approximate position of the mobile device may be extracted.

Accordingly, information may be received by a mobile device, which is carried by visible light so that conventional light sources for artificial illumination, in particular light emitting diodes, may be used to reliably transmit data in small range, e.g. up to 10 m.

According to an embodiment, the visible light receiver is adapted to convert the received modulated visible light into an electric signal. Accordingly, it is possible to process the signal electronically, using simple and cheap electronic components.

According to an embodiment, the mobile device comprises an intensity detector for determining the intensity of the received visible light. For example, if the visible light receiver converts received modulated visible light into an electric signal, the electric signal may be integrated and compared to a threshold or several different thresholds so as to obtain information regarding the overall light power received and thus regarding the illumination conditions around the mobile device.

According to an embodiment, the mobile device further comprises a signal divider for dividing the signal into a first component to be processed by the demodulator and a second component to be detected by an intensity detector. Accordingly, the received modulated visible light may be analysed in parallel, namely in one path a modulation component, which may vary in time, may be analyzed and in another path, an overall received power may be analyzed.

According to an embodiment, the mobile device further comprises a controller for processing the demodulated signal to use the information corresponding to the transmission data. Accordingly, by demodulating the signal, e.g. a modulation component of the signal would be sufficient, information corresponding to transmission data is received, indicating the location of the transmitting light source, for example, so as to be able to derive the approximate position of the mobile device.

According to an embodiment, the visible light is modulated with frequencies in a range between 100 kHz and 1 GHz and preferably between 1 MHz and 100 MHz. Further, the demodulator is adapted to demodulate the signal based on the visible light modulated with frequencies in the range between 100 kHz and 1 GHz and preferably between 1 MHz and 100 MHz. Accordingly, a high data rate can be obtained.

According to an embodiment, the visible light receiver comprises an ambient light sensor, for example an ambient light sensor as used in a mobile phone. Accordingly, adapting a mobile device, such as a mobile phone, to receive information through modulated visible light can be done inexpensively by reusing an existing ambient light sensor and providing suitable electronics for analysis.

Another embodiment of the invention provides an apparatus for transmitting information corresponding to transmission data by modulated visible light. The apparatus comprises a light source based on at least one light emitting diode (LED) for emitting visible light and a modulating circuit for modulating the transmission data onto an electric current to be applied to the light source. Further, the light source is adapted to emit modulated visible light carrying information corresponding to the transmission data when driven by the modulated electric current.

Accordingly, by applying a modulated electric current to a light source comprising an LED, it is possible to transmit information. An LED in particular easily provides a modulated light output when receiving a modulated electric current so that a frequency of up to 1 GHz may be modulated on emitted visible light.

Another embodiment of the invention provides a system for communicating transmission data that comprises the above-described mobile device and the above-described apparatus. Accordingly, the advantages of the mobile device and of the apparatus may be achieved.

Another embodiment of the invention provides a method for operating a mobile device comprising the steps of receiving at the mobile device modulated visible light carrying information corresponding to transmission data modulated onto visible light emitted from at least one light source, outputting a signal based on the received modulated visible light and demodulating the output signal to extract the information corresponding to the transmission data.

Accordingly, method is provided to operate a mobile device to obtain information through modulated visible light so as to provide data communication to a mobile device with simple means such as existing room lights or preferably future room lights based on LED technology.

Another embodiment of the invention provides a method for operating a system comprising a mobile device and an apparatus for transmitting information by modulated visible light from a light source to the mobile device. This method comprises the steps of modulating transmission data onto an electric current, applying the modulated electric current to the light source so that the light source emits modulated visible light carrying information corresponding to the transmission data and receiving at the mobile device modulated visible light carrying information corresponding to transmission data modulated onto modulated visible light emitted from the light source. The method further comprises the steps of outputting a signal based on the received modulated visible light and demodulating the output signal to extract the information corresponding to the transmission data.

Accordingly, a system is provided in which information is transmitted using modulated visible light.

### BRIEF DESCRIPTION OF THE DRAWINGS

FIG. 1 shows a mobile device according to an embodiment of the invention.

FIG. 2 shows elements of a mobile device, and in particular a signal flow in the mobile device, according to an embodiment of the invention.

FIG. 3 shows a flow chart of a method for operating a mobile device to extract information according to an embodiment of the invention.

FIG. 4 shows an apparatus for transmitting information by modulated visible light according to another embodiment of the invention.

FIG. 5 shows a system comprising a mobile device, such as a mobile phone, and an apparatus for transmitting information by modulated visible light.

FIG. 6 shows a flow chart of a method for operating a system, such as the system of FIG. 5, according to another embodiment of the invention.

### DESCRIPTION OF THE EMBODIMENTS

Preferred embodiments of the invention are described with reference to the figures. It is noted that the following description contains examples only and should not be construed as limiting the invention.

Embodiments of the invention generally relate to receiving and transmitting information corresponding to transmission data that is modulated onto visible light. Particularly, visible light emitted from one or more light emitting diodes can be easily modulated by supplying a modulated electric current to the LED(s).

However, the invention is not limited to light emitted from LEDs but may be applied to any light source that is responsive to frequency changes, preferably in the MHz range and higher, and outputs modulated visible light in this range. In the following, LED should not be construed as being limited to a diode based on classical semiconductor material but LED also comprises organic light emitting diodes (OLEDs) and the like.

LEDs are particular suitable, since energy consumption is low and lighting efficiency high. For example, the inventor realized that in future illumination systems, in which LEDs will be used commonly as an illuminating light source for homes and offices or even street lamps, etc., these light sources can be easily modulated to transmit information to mobile devices which are close enough to the light source to receive its light.

Although modulating electromagnetic radiation of electric discharge lamps, e.g. fluorescent lamps, has been previously described to produce electronically detectable variations for data transmission, such a technique requires complex electronic circuitry including an inverter to create a high-frequency AC voltage waveform to be applied to a fluorescent lamp, for example. This results in a small frequency range between a minimum frequency above the one of the human visual perception (at least higher than 100 Hz) so as to avoid perception of flicker to a human eye and a maximum frequency significantly below a switching frequency of the inverter, thus limiting the range of usable frequencies and thereby the usable data rate.

In the following similar or same reference signs indicate similar or same elements or steps.

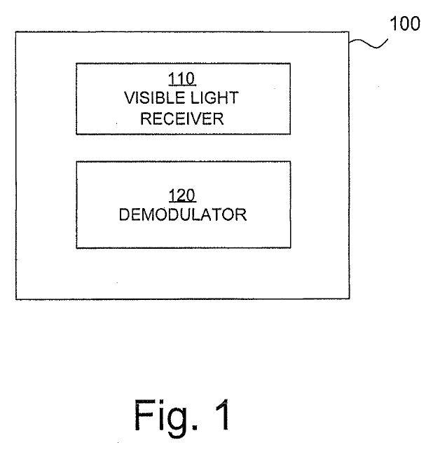

In the following, FIG. 1 illustrates elements of a mobile device 100 according to an embodiment of the invention. In details, the mobile device 100 comprises a visible light receiver 110 and a demodulator 120.

The mobile device 100 is adapted to receive modulated visible light from a light transmitting apparatus that will be described in detail with respect to FIG. 4 and may form part of a lamp network, i.e. illumination system, such as a lamp network which is commonly used for illumination purposes in residential, office or factory buildings.

The visible light receiver receives modulated visible light carrying information corresponding to transmission data. In detail, the transmission data is modulated onto visible light emitted from at least one light source, such as an LED, of the above-described lamp network. It is noted that modulated light is less sensitive to errors in transmission and thus longer distances with light even of lower power can be achieved. Several modulation techniques are known and can be used for modulating an LED emitting visible light, such as pulse width modulation or using a modulation frequency of an oscillator, which will be described in more detail below.

For example, the mobile device may be a portable computer such as a laptop or netbook, a personal digital assistant (PDA) or a mobile phone, wherein each of the devices may comprise a photodiode acting as a visible light receiver. In particular, mobile phones or cellular phone sometimes comprise an ambient light sensor. In this example, the ambient light sensor may be used as a part of the visible light receiver 110 to receive the modulated visible light. An ambient light sensor used for mobile phones is for example the ALS SFH 5711 of Osram Opto Semiconductors Inc.

Depending on the environment, the visible light receiver 110 receives only artificial light in the visible range, e.g. in an office without windows, sunlight, or a combination of artificial light and sunlight. By modulating the artificial light, e.g. from lamps in a room or street lamps comprising a light source preferably based on at least one light emitting diode (LED), this light in the visible range can be modulated to be easily differentiable from sunlight.

The visible light receiver 110, after receiving the visible light, outputs a signal based on the received modulated visible light. For example, the visible light receiver 110 converts the received modulated visible light into an electric signal, which comprises the same modulation, such as 36 kKz, if a ceramic resonator as known from TV remote controls is used to modulate the driving current of an LED. However, it is noted that the visible light of an LED may be modulated with frequencies in the MHz range, for example with ceramic resonators at a frequency of 20 MHz. Even higher frequencies may be realized when using quartz crystals as an oscillator.

To demodulate the signal, the mobile device 100 comprises a demodulator 120. In detail, the demodulator 120 demodulates the signal based on the received modulated visible light to extract the information corresponding to the transmission data. For example, the demodulator 120 is adapted to demodulate the signal based on the visible light modulated with one or more frequencies in the MHz range, i.e. in a range from several 100 kHz to 1 GHz.

The processing of light received by the mobile device may be summarized as follows. Modulated visible light carrying information corresponding to transmission data is received and converted into an electric signal. Then, the electric signal is amplified by an amplifier and fed into a filter unit. The filter unit may comprise a bandpass filter or other suitable filters to separate a modulation component of the electric signal from a DC component, for example. The modulation component is then demodulated by the demodulator 120.

If only one frequency for modulation is used, information may be transmitted by differentiating between an electric signal with and without modulation or an electric signal with modulation and no signal. Alternatively, or if more than one modulation frequency is used, the frequency may be tracked by a phase-locked loop (PLL), as known in the art. The PLL, for example, tunes a voltage controlled oscillator to the same frequency as the input signal so that the control voltage corresponds to the frequency and thus to the demodulated signal. Several modulation techniques are known such as frequency shift keying (FSK), quadrature phase shift keying (QPSK), etc. with which a higher data rate may be achieved.

Depending on the modulation and coding protocol to interpret the demodulated signal, it is possible to derive from the presence or absence of the modulation component of the signal or from the pulse width of the signal, if pulse width modulation is used, a digital coded signal. This digital coded signal is then supplied to a controller to extract the information corresponding to the transmission data from the light source. For example, the information corresponding to the transmission data modulated onto visible light may indicate the position, such as specific coordinates, of the light source that has been modulated. Therefore, the mobile device is enabled to derive its location, which corresponds roughly to the location of the light source within the range of light transmission. The range is usually smaller than 5 m so that the information carried by modulated visible light may be used for navigation purposes in buildings, in which no GPS signal reception is possible in general.

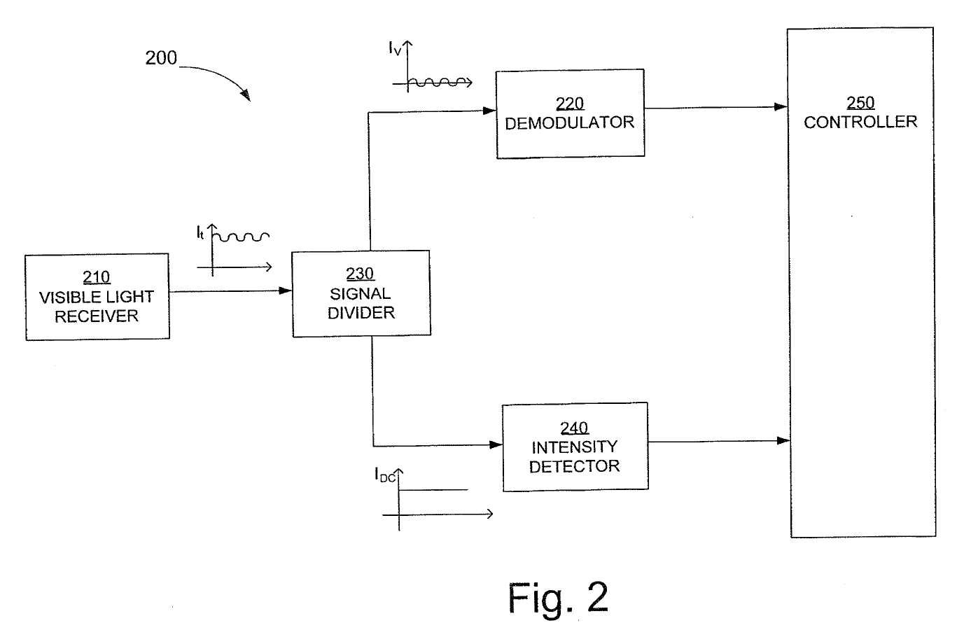

FIG. 2 illustrates elements of a mobile device 200 according to another embodiment of the invention. Similar to the mobile device of FIG. 1, the mobile device 200 of FIG. 2 comprises a visible light receiver 210 and a demodulator 220. Furthermore, the mobile device 200 comprises a signal divider 230, intensity detector 240 and controller 250.

As discussed above with respect to FIG. 1, and in particular with respect to the visible light receiver 110, the visible light receiver 210 similarly receives modulated visible light carrying information that is then converted into an electric signal and output. An example of an output electric signal Iₜ is shown for illustrative purposes between the visible light receiver 210 and the signal divider 230. This signal comprises a modulation component due to the transmission data modulated onto the visible light emitted at the light source of the light transmitting apparatus and a DC component, which is usually a mixture of a DC component of the visible light without modulation and background lights, for example from direct or indirect sunlight or other light sources influencing the illumination conditions at the mobile device 200.

The signal light divider 230 receives the output electric signal from the visible light receiver 210 and divides the signal into the modulation component Iᵥ and the DC component I_{DC}. Accordingly, the two components may be processed in parallel, namely the demodulator 210 may process the modulation component Iᵥ which is indicated in the diagram on the top of FIG. 2 and the intensity detector 240 may process the DC component I_{DC} which is indicated in the diagram on the bottom of FIG. 2. It is noted that the frequencies shown in FIG. 2 correspond to the modulation frequencies and should not be confused with the carrier frequency of the visible light, which is in the range of several thousands of THz and cannot be measured by a simple photodiode which only measures the square of the amplitude of the light and not the light frequency itself.

The intensity detector 240 determines the intensity of the received visible light by integrating the electric signal for a predetermined time period so as to compare the integrated signal with threshold values, for example. For example, different threshold values may be defined for an environment with a low light level, medium light level and high light level by the controller 250 so as to determine the light level of the environment, in which the mobile device is located by comparing the thresholds to the detected light level. According to the light level of the environment, a display of the mobile device may be controlled, for example, to save energy, so that in an environment with a low light level the display brightness is set to low and in an environment with a high light level, the display brightness is set too high.

It is noted that instead of using the signal divider 230 in the mobile device 200, the electric signal with a modulation component and DC component may be directly fed into a demodulator 220 for analyzing the modulation frequency and subsequently the signal can be integrated to determine the intensity by an intensity detector.

As shown in FIG. 2, the controller 250 receives the demodulated signal, which may be digitally coded, as described above, from the demodulator 220. As described above, the controller 250 processes the demodulated signal to use the information corresponding to the transmission data, for example, to receive location data or other information at the mobile device. If the transmission data comprises information regarding the position of the light source emitting the modulated visible light, such as its location in a building, an approximate location of the mobile device can be derived. For example, the transmission data may indicate a specific room on a specific floor, in which the light source is located so that the controller 250 may indicate on a display of the mobile device to the user that the user is in this specific room on that specific floor of the building. For example, the position of the user is superimposed as some kind of mark, e.g. a dot, on a map shown on the display. Therefore, if different light sources in different rooms of a building are adapted to emit information regarding their different positions, navigation in a building can be performed without the need of a GPS signal, even in three dimensions.

Furthermore, if the mobile device is adapted with a GPS (global positioning system) receiver and has previously detected its position via GPS, this position can be updated with the positioning information received from a light source.

Still further, a gyro-sensor and/or acceleration sensor for inertial navigation in the mobile device could be used to track the movement of the mobile device without the need for GPS, wherein the position is updated once light from a light source emitting modulated light is received

Additionally, as described above, the controller 250 receives an output signal from the intensity detector 240, which can be processed to obtain information regarding the light level of the environment, in which the mobile device is in.

Therefore, information, such as both location and light level environment, e.g. illumination conditions in a room, may be transmitted to a mobile device, such as mobile device 100 or 200, without the need for user activated connections like Bluetooth or WLAN, etc. The small range of visible light emitting LEDs, which is usually below 5 m, is perfect for indoor navigation with high precision. In addition to the positioning information, also maps and other location based content may be transmitted by the light output from a light source.

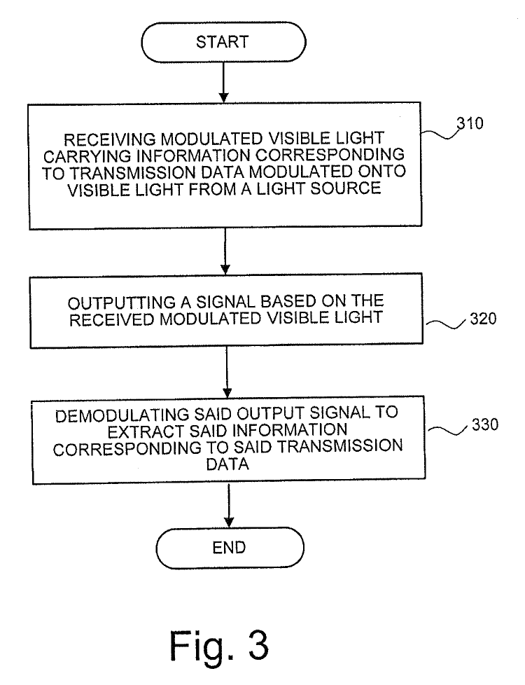

In the following, operations of a mobile device will be described with respect to FIG. 3. FIG. 3 shows a flow diagram of operations of a method for operating a mobile device, such as during operation of the mobile device 100 or the mobile device 200, shown in FIGS. 1 and 2, respectively.

As described above, the mobile device may be located indoors or outdoors and receive artificial modulated visible light carrying information emitted from a light source.

In a first step 310, the mobile device receives modulated visible light carrying information corresponding to transmission data modulated onto visible light emitted from at least one light source, such as an LED being a part of an indoor or outdoor light source.

In a subsequent step 320, a signal based on the received modulated visible signal, such as an electric signal converted from the light signal having the corresponding modulation, is output. Then, in step 330, the output signal is demodulated to extract the information corresponding to the transmission data. Several techniques for demodulation are known depending on the type of modulation and some of which have been described above.

In the following, an apparatus for transmitting or sending information by modulated visible light carrying the information corresponding to transmission data, will be described in detail with respect to FIG. 4.

FIG. 4 shows an apparatus 400 comprising a modulating circuit 410 and a light source 420 based on at least one light emitting diode 415.

The modulating circuit 410 modulates transmission data on an electric current to be applied to the light source 420. In detail, the modulating circuit 410 may comprise a ceramic resonator or quartz crystal oscillator to generate a modulation frequency. As described above, several modulation techniques are known such as frequency modulation or pulse width modulation and in a one case a 36 kHz frequency of an oscillator can be modulated on a carrier signal, such as light, wherein the light is switched on and off to create bursts and pauses so that Manchester coding can be used, for example.

The modulated electric current is then applied to the light source, which is based on at least one LED for emitting visible light, and particularly emitting modulated visible light according to the modulated electric current so that the modulated visible light carries information corresponding to the transmission data when driven by the modulated electric current.

For example, it is expected that LEDs will be increasingly used as artificial light for illuminating the interior of buildings, such as office buildings and residential homes, as well as illuminating streets and squares outdoors. The light from an LED can be modulated easily up to frequencies in the MHz range so that information and navigation using the normal lamp network can be broadcast.

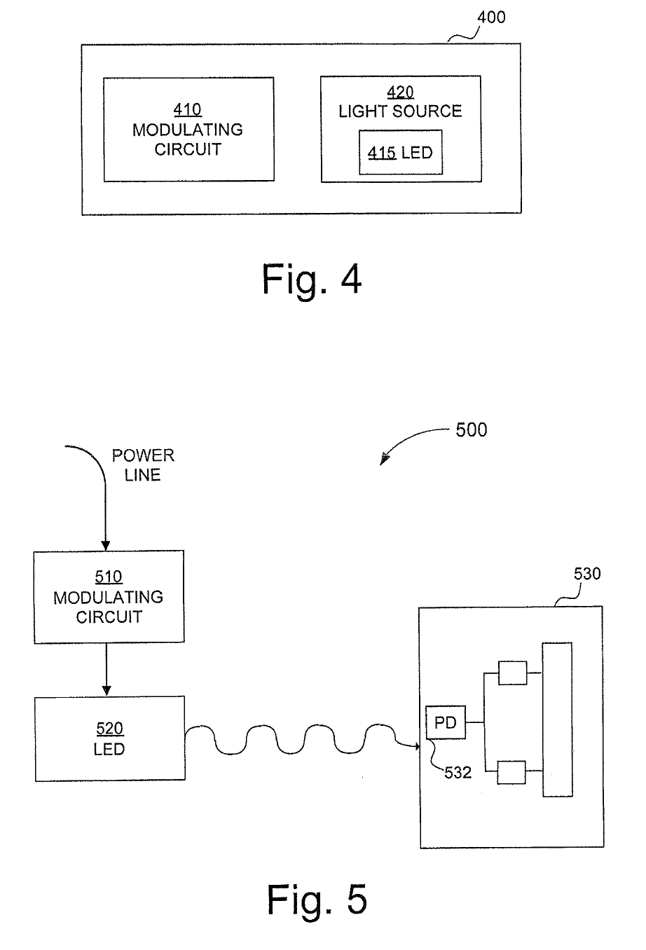

In FIG. 5, a system comprising the above-described apparatus and mobile device is shown. As shown in the system 500 of FIG. 5, a current coming from a power line to be supplied to an LED is first modulated by a modulating circuit 510. Conventionally, the voltage of the mains, e.g. 220V or 110V AC, is first down-converted to be suitable for driving an LED 520. Or another suitable power supply is used, e.g. a 6V battery. Then a modulated electric current from the modulating circuit 510 is fed in the LED 520, which is the single light source in the example of FIG. 5.

The LED 520 emits then modulated visible light carrying information corresponding to the transmission data when driven by the modulated electric current of the modulating circuit 510 to the mobile device 530, for example a mobile phone.

This light is detected by the visible light receiver 532, illustrated as a photodiode in FIG. 5, and converted to an electric signal with variations in the intensity due to the modulation. As described above, these variations in the intensity, the modulation component, can be used to extract information and from the intensity itself, the illumination condition around the mobile device 530 can be determined, similar to the function of an ambient light sensor.

For example, in the case of mobile phones comprising an ambient light sensor, the mobile phone can be adapted so that the output of the ambient light sensor can be used for two purposes, namely for extracting information from a modulation component and for deriving the light level of the environment, in which the mobile phone is in so as to adjust the brightness of its display.

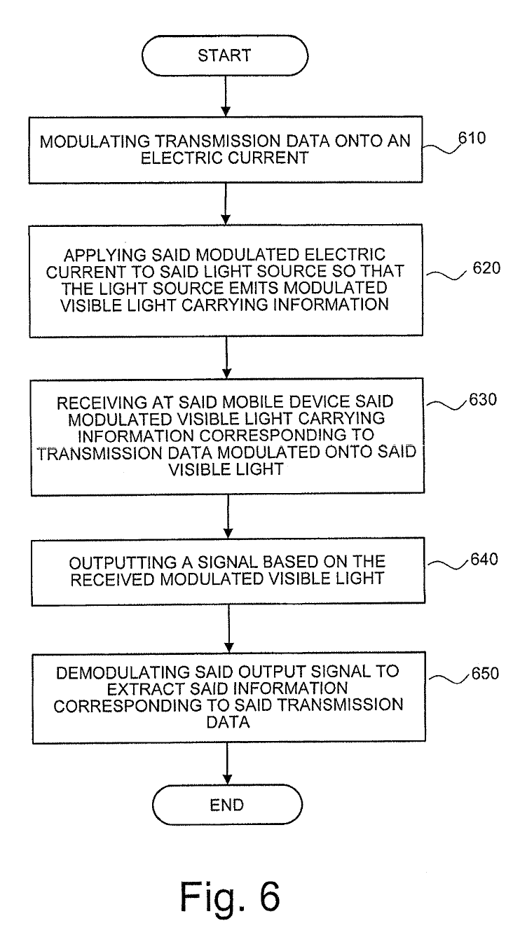

With respect to FIG. 5, the system 500 comprising the mobile device 530, which is similar to the mobile device 100 or 200, and an apparatus having the modulating circuit 510 and the LED 520 has been described. In the following, operations of a method for operating a system comprising a mobile device and an apparatus for transmitting information corresponding to transmission data by modulated visible light from a light source to a mobile device will be described with respect to FIG. 6. FIG. 6 shows a flow diagram of operations of a method for operating the system, such as the system 500,

In a first step 610, transmission data is modulated onto an electric current. As described above, the electric current is based on the current of a power line, which conventionally has to be converted to a suitable current and voltage for the light source used, such as an LED. Then, in step 620, the modulated electric current is supplied to the light source so that the light source emits modulated visible light carrying information corresponding to the transmission data.

Subsequently, in step 630, the mobile device receives the modulated visible light carrying information corresponding to the transmission data modulated onto the visible light emitted from the light source. This step basically corresponds to step 310 of FIG. 3, since it relates to the operation of the mobile device. Similarly, steps 540 and 550 of FIG. 5 describing outputting a signal based on the received modulated visible light and demodulating the output signal to extract the information corresponding to the transmission data also correspond to steps 320 and 330 of FIG. 3 and thus a more detailed explanation will be omitted to avoid unnecessary repetition.

In previously described FIGS. 1, 2, 4 and 5 individual elements of the described mobile devices and apparatus have been explained in detail, wherein the elements comprise several different functions. It is understood by the skilled person that the elements in the above-described embodiments should not be construed as being limited to a separate tangible part but should be understood as a kind of functional entity so that several functions may be provided in one tangible part.

It will be appreciated that various modifications and variations can be made in the described elements, mobile devices, apparatus, system and methods as well as in the construction of this invention without departing from the scope or spirit of the invention. The invention has been described in relation to particular embodiments which are intended in all the aspects to be illustrative rather than restrictive. Those skilled in the art will appreciate that many different combinations of hardware, software and firmware are suitable for practicing the invention.

Moreover, other implementations of the invention will be apparent to the skilled person from consideration of the specification and practice of the invention disclosed herein. It is intended that the specification and the examples be considered as exemplary only. To this end, it is to be understood that inventive aspects lie in less than all the features of the single forgoing disclosed implementation or configuration. Thus, the true scope and spirit of the invention is indicated by the following claims.

1. A mobile device, comprising
a visible light receiver for receiving modulated visible light carrying information corresponding to transmission data modulated onto visible light emitted from at least one light source and for outputting a signal based on the received modulated visible light; and
a demodulator for demodulating said signal based on the received modulated visible light to extract said information corresponding to said transmission data.

2. The mobile device according to claim 1, wherein
said visible light receiver is adapted to convert the received modulated visible light into an electric signal.

3. The mobile device according to claim 1, further comprising
an intensity detector for determining the intensity of the received visible light.

4. The mobile device according to claim 1, further comprising
a signal divider for dividing said signal into a first component to be processed by said demodulator and a second component to be detected by an intensity detector.

5. The mobile device according to claim 1, further comprising
a controller for processing said demodulated signal to use said information corresponding to said transmission data.

6. The mobile device according to claim 1, wherein
said visible light is modulated with frequencies in a range between 100 kHz and 1 GHz and preferably between 1 MHz and 100 MHz, and said demodulator is adapted to demodulate said signal based on said visible light modulated with frequencies in said range.

7. The mobile device according to claim 1, wherein
the visible light receiver comprises an ambient light sensor.

8. The mobile device according to claim 1,
wherein the mobile device is a mobile phone.

9. Apparatus for transmitting information corresponding to transmission data by modulated visible light, comprising
a light source based on at least one light emitting diode for emitting visible light; and
a modulating circuit for modulating said transmission data onto an electric current to be applied to said light source,
wherein said light source is adapted to emit modulated visible light carrying information corresponding to said transmission data when driven by said modulated electric current.

10. System for communicating transmission data, comprising
said mobile device according to claim 8; and further comprising
apparatus for transmitting information corresponding to transmission data by modulated visible light, including
a light source based on at least one light emitting diode for emitting visible light; and
a modulating circuit for modulating said transmission data onto an electric current to be applied to said light source,
wherein said light source is adapted to emit modulated visible light carrying information corresponding to said transmission data when driven by said modulated electric current.

11. Method for operating a mobile device, comprising the steps
receiving at the mobile device modulated visible light carrying information corresponding to transmission data modulated onto visible light emitted from at least one light source;
outputting a signal based on the received modulated visible light; and
demodulating said output signal to extract said information corresponding to said transmission data.

12. Method for operating a system comprising a mobile device and an apparatus for transmitting information corresponding to transmission data by modulated visible light apparatus from a light source to said mobile device, comprising the steps
modulating transmission data onto an electric current;
applying said modulated electric current to said light source so that the light source emits modulated visible light carrying information corresponding to said transmission data;
receiving at said mobile device said modulated visible light carrying information corresponding to said transmission data modulated onto said visible light emitted from said light source;
outputting a signal based on the received modulated visible light; and
demodulating said output signal to extract said information corresponding to said transmission data.
